(19) United States
(12) Patent Application Publication
(10) Pub. No.: US 2020/0002164 A1
(43) Pub. Date: Jan. 2, 2020

(54) HYDROGEN GAS GENERATING SYSTEM AND METHOD WITH BUFFER TANK

(71) Applicant: GALAXY FCT SDN. BHD., Petaling Jaya (MY)

(72) Inventors: Yoke Keen YEE, Petaling Jaya (MY); Albert Kok Foo NG, Subang Jaya (MY); Chin Yang CHIA, Subang Jaya (MY)

(73) Assignee: GALAXY FCT SDN. BHD., Petaling Jaya (MY)

(21) Appl. No.: 16/482,693

(22) PCT Filed: Jun. 28, 2017
(86) PCT No.: PCT/MY2017/050033

§ 371 Date: Jul. 31, 2019

Related U.S. Application Data
(63) Continuation-in-part of application No. PCT/MY2017/050007, filed on Feb. 3, 2017.

(30) Foreign Application Priority Data
Feb. 3, 2017 (MY) PCT/MY2017/050007

(51) Int. Cl. C01B 3/06; B01J 8/02; B01J 8/00; H01M 8/065; H01M 16/00; B01D 5/00

(52) U.S. Cl. CPC C01B 3/065; B01J 2208/00637; B01J 8/0285; B01J 8/006; B01J 8/001; H01M 8/065; H01M 16/006; B01D 5/0072; B01D 5/0054; B01J 2208/00539; B01J 2208/00548; B01J 2208/00407; B01J 2208/00415; B01J 2208/00814; B01J 8/0278

(57) ABSTRACT

A hydrogen gas generating system that heats a liquid reactant such as water, then channeling the resultant heated reactant to a reaction chamber containing a solid hydride. The chemical reaction between the heated liquid reactant and solid hydride forming hydrogen gas. This hydrogen gas is then filtered and regulated before being stored in a buffer tank. Hydrogen gas from the buffer tank can then be supplied to a fuel cell to produce electricity as and when needed, such as when a battery goes below a predetermined level. The pressure of the buffer tank is measured and used to ascertain when the hydrogen gas generation should start and stop. A pressure and temperature of the reaction chamber is measured as a safety precaution, whereby the reaction will be stopped if the pressure and temperature exceeds predetermined values.

### TECHNICAL FIELD

The present invention relates generally to a hydrogen gas generating system and method thereof, and more particularly to such a system and method that is provided with a buffer tank.

### BACKGROUND ART

Fuel cells that produce electricity using hydrogen gas as a fuel source are well known. Fuel cell applications are for the most part mobile, and that creates a problem to provide a constant supply of hydrogen gas to power the fuel cell. A traditional solution to this is to carry hydrogen gas in pressurized tanks. These pressurized tanks are often heavy and bulky, which is not suitable for applications where weight is a concern, such as UAV and bicycle applications. Another problem is pressurized hydrogen gas tanks is the low energy storage density. Yet another problem is the risk of leakage. Hydrogen gas is odourless and burns without any flame, making it especially hazardous in the case of a leak.

An alternative to carrying hydrogen gas around in pressurized tanks is to generate hydrogen gas in situ, and “on demand”. It is known that certain solid hydrides or borohydrides, when mixed with liquids such as water, can undergo a hydrolysis chemical reaction that produces hydrogen gas. This eradicates all the technical and hazardous drawbacks of carrying hydrogen gas around in pressurized tanks. A typical example of solid hydride hydrogen gas generation is using sodium borohydride (NaBH4) as fuel. A common practice is mixing sodium borohydride (NaBH4) with sodium hydroxide (NaOH) to form an aqueous solution. When a noble metal catalyst such as platinum or ruthenium is introduced, hydrolysis of NaBH4 will take place and hydrogen gas is produced. During the hydrolysis process, NaBH4 will be transformed into sodium borate (NaBO2), which is insoluble in the alkaline aqueous. NaBO2 precipitation also tends to cloak up the catalyst surface area and render the reaction terminated.

The use of liquid NaBH4 as a fuel also presents other technical problems in a hydrogen generating system. The presence of excess water gives rise to unwanted weight, thus reducing the specific storage density of the hydrogen generator. A liquid mixture also poses a higher risk of an uncontrollable runaway reaction, which may lead to catastrophic consequences.

PCT/MY2017/050007 (Yee, et al), which the present application is claiming the priority of, solves these problems with a hydrogen gas generating system that heats a liquid reactant such as water, then channels the resultant heated reactant to a reaction chamber containing a solid hydride. The chemical reaction between the heated liquid reactant and solid hydride forms hydrogen gas. One problem with the system of PCT/MY2017/050007 is a slow reaction start time due to the lag between when the hydrogen gas output drops, and the pressure drop within the reaction chamber itself. This results in a lag between the actual output pressure drop, and the start of the reaction.

Another problem with the system of PCT/MY2017/050007 is the difficulty in designing a system to generate hydrogen gas at a rate that can always meet the demand.

A third problem with the system of PCT/MY2017/050007 is the reaction chamber operating at less than optimal rates. This is because the rate of reaction is tied in to the demand of the hydrogen gas, instead of being independent of the demand, and hence able to stay at an optimal rate.

It is therefore desirable to have a hydrogen generating system with a reduced or eliminated reaction start time.

Accordingly, it is another objective of this invention to provide a system that is able to output hydrogen gas at a rate that always meets the demand.

It is another object of this invention to provide a system that generates hydrogen gas at optimal rates, thus saving on reactants and cost.

### SUMMARY OF INVENTION

The present invention seeks to overcome the aforementioned disadvantages by providing a hydrogen gas generating system and method such as the one taught in PCT/MY2017/050007, but with the addition of a buffer tank after the reaction chamber and filter.

The present invention thus relates to a hydrogen gas generating system that heats a liquid reactant such as water, then channeling the resultant heated reactant to a reaction chamber containing a solid hydride. The chemical reaction between the gasified liquid reactant and solid hydride forming hydrogen gas. This hydrogen gas is then filtered before being stored in a buffer tank. Hydrogen gas from the buffer tank can then be supplied to a fuel cell to produce electricity as and when needed, such as when a battery goes below a predetermined level. The pressure of the buffer tank is measured and used to ascertain when the hydrogen gas generation should start and stop. A pressure and temperature of the reaction chamber is measured as a safety precaution, whereby the reaction will be stopped if the pressure and temperature exceeds predetermined values.

This invention thus relates to a hydrogen generating system, which includes a control unit having an energy storage reading input, a pressure reading input, a temperature reading input, a liquid driving unit controlling output, a heating controlling output, and a gaseous release controlling output. This hydrogen generating system also includes a liquid storage having an intake port for receiving a liquid reactant from an external source, an exhaust port for expelling the liquid reactant from the liquid storage, and an excess intake port for receiving excess liquid recovered from a condensation unit. This hydrogen generating system also includes a liquid heating unit having an exhaust port, an intake port for receiving liquid reactant from the liquid storage, heating elements controllable by the control unit via the heating controlling output, the liquid heating unit adapted to heat an amount of liquid reactant such that a portion of the liquid reactant enters a gaseous phase. This hydrogen generating system also includes a reaction chamber having an intake port in fluid communication with the liquid heating unit exhaust port via a control valve, the control valve controlled by the gaseous release controlling output, the reaction chamber containing a solid reactant, such as a metal hydride, and adapted to receive an amount of heated reactant from the liquid heating unit, the heated reactant dispersed into the solid reactant thereby forming a chemical reaction that produces hydrogen gas. A product gas being a mixture of any excess heated reactant and the produced hydrogen gas is expelled from the reaction chamber via a gas outlet. This hydrogen generating system also includes a pressure sensing means for taking a pressure reading at the reaction chamber intake port and relaying the pressure reading to the control unit. This hydrogen generating system also includes a temperature sensing means for taking a temperature reading inside the reaction chamber and relaying the temperature reading to the control unit. This hydrogen generating system also includes a condensation unit having an intake port for receiving the product gas from the reaction chamber, an exhaust port for channeling primarily hydrogen gas out of the condensation unit, an excess liquid port for channeling a condensate of the heated reactant out of the condensation unit and back into the liquid storage, the condensation unit adapted to substantially condense the heated reactant.

In a further embodiment, the said heated reactant is further heated in the liquid heating unit until it is gasified, or enters a gaseous state.

The system further comprises a buffer tank located downstream of the condensation unit, the buffer tank adapted to receive and store an amount of hydrogen gas, and the buffer tank provided with a pressure sensing means. This pressure of the buffer tank is used to ascertain a start and stop of said hydrogen gas reaction. Because the buffer tank is able to hold hydrogen gas at a higher pressure, the hydrogen gas generation reaction can be less dependent on the demand, and hence able to stay at a more optimal rate.

The nominal operating pressure range for the buffer tank is between 1 Bar and 100 Bar. The nominal operating temperature range for the buffer tank is between 1° C. and 60° C. The buffer tank is fitted with a safety valve that is designed to release stored gas and thus reduce pressure if the buffer tank pressure exceeds a predetermined level.

In another aspect of this invention, this hydrogen generating system further comprises a filter unit adapted to filter said primarily hydrogen gas thereby substantially removing unwanted particles from said primarily hydrogen gas.

In another aspect of this invention, this hydrogen generating system further comprises a liquid driving unit provided between the said liquid storage exhaust port and said liquid heating unit intake port, and adapted to propel liquid reactant from said liquid storage and into said liquid heating unit, said liquid driving unit controllable by the said control unit.

In another aspect of this invention, this hydrogen generating system further comprises a control valve adapted to allow release of said product gas from said reaction chamber, said control valve controllable by the said control unit.

In another aspect of this invention, the liquid heating unit is adapted to store an amount of said heated reactant.

In another aspect of this invention, this hydrogen generating system further comprises a heat transfer means adapted to transfer heat from said reaction chamber to said liquid heating unit.

In another aspect of this invention, this hydrogen generating system further comprises a fuel cell adapted to generate electricity from a supply of hydrogen gas, said fuel cell located downstream of said buffer tank, and an energy storage an energy storage, such as a battery, said energy storage adapted to receive and store an amount of electrical energy from said fuel cell. A storage level of this energy storage is relayed to the control unit.

In another aspect of this invention, the control unit releases hydrogen gas stored in said buffer tank and sends it to said fuel cell when the storage level of the energy storage is reduced to a preset level.

In another aspect of this invention, this hydrogen generating system further comprises a fuel cell having an intake port for receiving an amount of the primarily hydrogen gas for conversion to electrical energy.

In another aspect of this invention, a portion of the electrical energy produced by the fuel cell is used to power an external electrical load and another portion of the electrical energy produced is used to charge the energy storage.

In another aspect of this invention, this hydrogen generating system further comprises a means of ensuring that the liquid reactant flows out of the liquid storage so long as there is adequate liquid reactant in the liquid storage. This means of ensuring that the liquid reactant flows out of the liquid storage comprises a flexible hose with a first end connected to a floatation device, and a second end in fluid communication with the liquid storage exhaust port, and such that the floatation device is adapted to keep the first end of the flexible hose underneath the surface of the liquid reactant, as long as there is adequate liquid reactant in the liquid storage. In this way, the flexible hose is able to extract liquid reactant from the liquid storage regardless of the orientation of the liquid storage.

In another aspect of this invention, the liquid reactant includes any of: water, acidic liquid, alkaline liquid, organic or inorganic liquids or a combination thereof.

In another aspect of this invention, the solid reactant comprises of a mixture of hydrogen fuel and a metal based catalyst.

In another aspect of this invention, the hydrogen fuel is sodium borohydride.

In another aspect of this invention, the hydrogen fuel is any of: boron hydride, nitrogen hydride, carbon hydride, metal hydride, boron nitrogen hydride, boron carbon hydride, nitrogen carbon hydride, metal boron hydride, metal nitrogen hydride, metal carbon hydride, metal boron nitrogen hydride, metal boron carbon hydride, metal carbon nitrogen hydride, boron nitrogen carbon hydride, metal boron nitrogen carbon hydride, or the combination thereof.

In another aspect of this invention, the hydrogen fuel is any of: NaH, LiBH4, LiH, CaH2, Ca(BH4)2, MgBH4, KBH4, Al(BH3)3, or the combination thereof.

In another aspect of this invention, the solid reactant may be various compounds having BxNyHz, where x, y and z are any integer numbers. The various compounds may include: H3BNH3, H2B(NH3)2BH3, NH2BH2, B3N3H6, morpholineborane (C4H12BNO), (CH2)4O composite material, B2H4, or a combination thereof.

In another aspect of this invention, the metal based catalyst is any of: a cobalt based oxide, a boride, a solid acid, a salt, or a combination thereof. The salt can be a compound of the ions of any of: ruthenium (Ru), cobalt (Co), nickel (Ni), copper (Cu), iron (Fe) or a combination thereof.

In another aspect of this invention, the hydrogen generating system further comprises a gas regulating means located after the filter and before the buffer tank, the gas regulating means adapted to regulate a pressure and flow rate of a gas passing through it.

In another aspect of this invention, the reaction chamber is easily removable from the system and provided with means of temporarily closing the intake port and gas outlet during its removal. This facilitates easy changing of a reaction chamber when the solid reactant inside is used up.

In another aspect of this invention, the heating elements can be operated electrically by resistive heating or inductive heating. The said condensation unit further comprises an excess liquid port for channeling a condensate of said heated reactant out of said condensation unit and back into said liquid storage.

In another aspect of this invention, a pressure and temperature sensing means is further provided for taking pressure and temperature readings of said reaction chamber and relaying said pressure and temperature readings to said control unit, said control unit stopping the hydrogen gas generation in the reaction chamber if said reaction chamber pressure and temperature readings exceed a preset value.

Another aspect of this invention is a method of generating hydrogen gas, comprising the following steps:

a. detect a pressure level of a buffer tank;

b. if said pressure level has reduced to a predetermined level, activate a liquid driving unit that propels a liquid reactant from a liquid storage into a liquid heating unit;

c. activate heating elements in said liquid heating unit such that at least a portion of the said liquid reactant is gasified;

d. allow the said heated reactant to disperse inside a reaction chamber containing an amount of solid reactant, the contact between the said heated reactant and solid reactant producing hydrogen gas;

e. condense any heated reactant mixed with said hydrogen gas to separate it from the said hydrogen gas;

f. return said condensed heated reactant to said liquid storage;

g. filter said hydrogen gas to substantially remove unwanted particles;

h. transfer an amount of heat generated in the said reaction chamber to the said liquid heating unit;

i. regulate a pressure and flow rate of the said hydrogen gas; and

j. store said hydrogen gas in said buffer tank.

Other objects and advantages will be more fully apparent from the following disclosure and appended claims.

### Technical Problem

Difficulty in matching a generation of hydrogen gas with a demand.

Slow reaction start time in hydrogen gas generation system.

Unable to run reaction at optimal rates due to tie-in with demand.

### Solution to Problem

A hydrogen gas generating system that heats a liquid reactant such as water, then channeling the resultant heated reactant to a reaction chamber containing a solid hydride. The chemical reaction between the heated liquid reactant and solid hydride forming hydrogen gas. This hydrogen gas is then filtered and regulated before being stored in a buffer tank. Hydrogen gas from the buffer tank can then be supplied to a fuel cell to produce electricity as and when needed, such as when a battery goes below a predetermined level. The pressure of the buffer tank is measured and used to ascertain when the hydrogen gas generation should start and stop. A pressure and temperature of the reaction chamber is measured as a safety precaution, whereby the reaction will be stopped if the pressure and temperature exceeds predetermined values.

The hydrogen gas generating system of this invention also recovers extra heat from the reaction to assist in heating the liquid reactant, and in some instances heating the reactant to the point of gasification.

### BRIEF DESCRIPTION OF DRAWINGS

FIG. 1 illustrates a diagrammatic view of a hydrogen generating system in an embodiment of the present invention.

FIG. 2 illustrates a cross-sectional view of a reaction chamber in an embodiment of the present invention.

FIG. 3 illustrates a cross-sectional view of a liquid storage in an embodiment of the present invention.

FIG. 4 illustrates an external and cross-sectional view of a liquid heating unit in an embodiment of the present invention.

FIG. 5 illustrates a diagrammatic view of a portion of a hydrogen generating system in an embodiment of the present invention.

### DESCRIPTION OF EMBODIMENTS

It should be noted that the following detailed description is directed to a hydrogen generating system and method thereof, and is not limited to any particular size or configuration but in fact a multitude of sizes and configurations within the general scope of the following description.

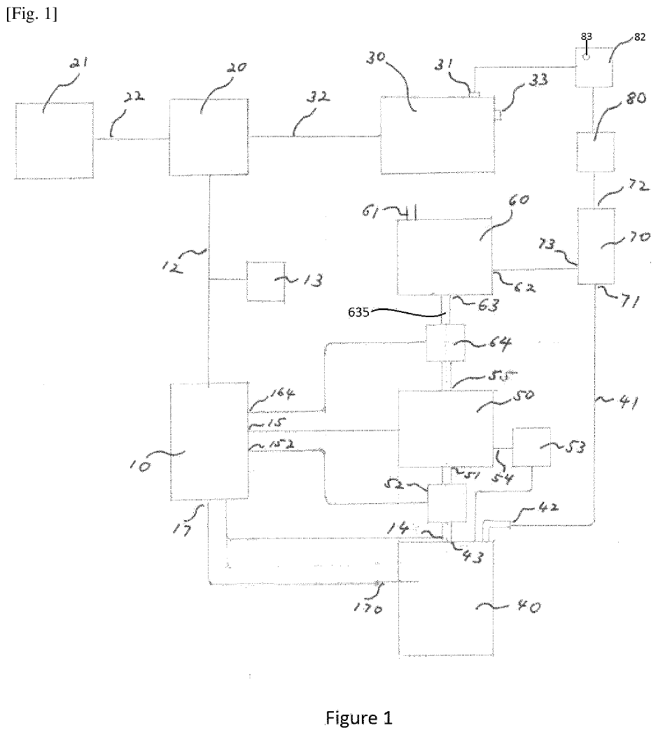

Referring to FIG. 1, there is shown a hydrogen generating system. The overall purpose of this system is to generate hydrogen gas for electricity production in a fuel cell in situ, thus eliminating the need for storing large amounts of pressurized hydrogen gas. There is shown an energy storage (13), which in preferred embodiments can be a battery or capacitor. When a sensor detects a drop of energy level in the energy storage (13) below a preset level, a control unit (10) initiates a hydrogen gas generating process. In a preferred embodiment, the control unit (10) includes a microcontroller.

This hydrogen gas generating process includes the control unit (10), via heating controlling output (15), switching on heating elements (56) of a liquid heating unit (50). This causes an internal temperature of the liquid heating unit (50) to increase. When the internal temperature of the liquid heating unit (50) reaches a preset value, the control unit (10) will, via liquid driving unit controlling output (164), activate a liquid driving unit (64). This liquid driving unit (64) is adapted to pump liquid reactant (91) that is stored in a liquid storage (60), out via a liquid storage exhaust port (63), through a liquid flow guide (635), and into the liquid heating unit (50) via a liquid heating unit intake port (55). As the liquid reactant (91) enters the liquid heating unit (50), it rapidly heats up. This heated reactant (90) is stored and pressurized in the liquid heating unit (50).

In one embodiment, the said heated reactant (90) is further heated in the liquid heating unit (50) until it is gasified, or enters a gaseous state.

Still referring to the hydrogen gas generating process, the control unit (10), via a gaseous release controlling output (152), activates a control valve (52). This control valve (52) when activated releases the stored heated reactant (90) out from the liquid heating unit (50) via a liquid heating unit exhaust port (51). The heated reactant (90) then passes through the control valve (52) and enters a reaction chamber (40) via a reaction chamber intake port (43). Upon entering the reaction chamber (40), the heated reactant reacts chemically with a solid reactant (47) that is stored in the reaction chamber (40). A pressure of the reaction chamber (40) is measured by a pressure sensing means (14). This pressure reading is fed back to the control unit (10). A temperature of the reaction chamber (40) is also measured by a temperature sensing means (170), and this temperature reading is also fed back to the control unit (10). When these pressure and temperature readings reach a preset value, the control unit (10) is able to shut down the reaction in the reaction chamber (40) by closing the control valve (52) thereby stopping the supply of heated reactant (90) into the reaction chamber (40). This is a safety measure.

The reaction between the heated reactant and the solid reactant (47) in the reaction chamber (40) produces hydrogen gas, among other by-products.

This reaction is an exothermic reaction, and thus increases the temperature of the reaction chamber (40). This excess heat energy is transferred back to the liquid heating unit (50) via a heat transfer device (53) located in between the reaction chamber (40) and the liquid heating unit (50). This heat transfer device (53) conductively transfers the excess heat produced in the reaction chamber (40) to the liquid heating unit (50) by means of a heat conductor (54). This reduces the power requirement of the heating element (56) in the liquid heating unit (50) and further enhances the output performance of this hydrogen gas generating system.

Primarily hydrogen gas and some other by-products is produced by the reaction between the said heated reactant and solid reactant (47) in the reaction chamber (40). A product gas, which is a mixture of this primarily hydrogen gas and any excess said heated reactant (90) which did not react with the solid reactant (47), is channeled out from the reaction chamber (40) through a gas outlet (42) and via a gas flow guide (41) into a condensation unit (70).

To further clarify the workings of the reaction chamber (40):

A gas that has been heated in the liquid heating unit (50), which we call heated reactant (90), enters the reaction chamber (40).

This heated reactant (90) reacts with a solid reactant (47) provided in the reaction chamber (40); this reaction producing primarily hydrogen gas and some by-products.

A product gas, which is a mixture of said primarily hydrogen gas and any excess heated reactant (90), is expelled from the reaction chamber.

This condensation unit (70) is provided with an intake port (71) for receiving the said product gas from the reaction chamber (40). The primary function of this condensation unit (70), is to condense the said heated reactant (90) back into a liquid, so that it separates from the primarily hydrogen gas. The resulting condense liquid is then channeled out through an excess liquid port (73) to return to the liquid storage via a liquid storage return port (62). The primarily hydrogen gas is expelled from the condensation unit (70) via an exhaust port (72) into a filter unit (80). The filter unit (80) traps unwanted particles in the primarily hydrogen gas, to make it purer.

After the filter unit (80), the hydrogen gas is channeled into a buffer tank (82), where it is stored. The buffer tank (82) is provided with a pressure sensor (83) that is able to measure a pressure reading within said buffer tank (82). This pressure reading is sent to the control unit (10). The control unit (10) uses this buffer tank pressure reading to calculate an optimal reaction rate of said hydrogen gas generation in the reaction chamber (40). The nominal operating pressure range for the buffer tank is between 1 Bar and 100 Bar. The nominal operating temperature range for the buffer tank is between 1° C. to 60° C. The buffer tank is fitted with a safety valve that is designed to release stored gas and thus reduce pressure if the buffer tank pressure exceeds a predetermined level.

A fuel cell unit (30) is located downstream of said buffer tank (82), and received hydrogen gas from said buffer tank (82) through an intake port (31), which in a preferred embodiment, is a valve. The hydrogen gas undergoes an electrochemical conversion in the fuel cell (30) to produce electrical energy. An exhaust gas produced by the fuel cell (30) is channeled out through an exhaust means (33), which in a preferred embodiment, is a valve. The fuel cell (30) can be any device which converts hydrogen gas into usable electric energy, and can be any of, but not limited to, the following: a proton exchange membrane fuel cell (PEMFC), alkaline fuel cell (AFC), phosphoric acid fuel cell (PAFC), molten carbonate fuel cell (MCFC), solid oxide fuel cell (SOFC), or other sorts of fuel cells.

In this preferred embodiment, electrical energy produced by the fuel cell (30) is channeled through an electric power converter (20), which can be any of, but not limited to: DC converter, inverter, or charge controller. The electric power converter (20) then outputs a portion of the said electrical energy to an electric load (21) through load interconnect (22). At the same time, another portion of the said electrical energy is sent back to the energy storage (13) via a recharge interconnect (12). This charges the energy storage (13) when needed. Yet another portion of the said electrical energy is used to power the control unit (10).

In other embodiments, the hydrogen generating system of the present invention can be used without the fuel cell, in any application where a supply of hydrogen gas is needed.

Still referring to FIG. 1, it can be seen that the liquid storage (60) is provided with a liquid storage intake port (61) through which liquid reactant (91) can be added. In a preferred embodiment, the liquid reactant (91) is water. However, the liquid reactant (91) can also be a diluted concoction of methyl alcohol, ethyl alcohol, and any other organic or inorganic solvent, such as ethylene glycol.

The solid reactant stored in the reaction chamber (40) comprises of a powder mixture of hydrogen fuel with a metal based catalyst. In a preferred embodiment, the hydrogen fuel is sodium borohydride. However, in other embodiments, this hydrogen fuel can also be other types of solid hydrides, such as boron hydride, nitrogen hydride, carbon hydride, metal hydride, boron nitrogen hydride, boron carbon hydride, nitrogen carbon hydride, metal boron hydride, metal nitrogen hydride, metal carbon hydride, metal boron nitrogen hydride, metal boron carbon hydride, metal carbon nitrogen hydride, boron nitrogen carbon hydride, metal boron nitrogen carbon hydride, or combinations thereof. This hydrogen fuel can also include: NaH, LiBH4, LiH, CaH2, Ca(BH4)2, MgBH4, KBH4 and Al(BH3)3, or combinations thereof. In addition, the solid reactant may be various compounds having BxNyHz and include, but not limited thereto, H3BNH3, H2B(NH3)2BH3, NH2BH2, B3N3H6, morpholineborane (C4H12BNO), (CH2)4O composite material, B2H4, or combinations thereof. In preferred embodiments, the metal based catalyst is made of cobalt based oxide or boride, or may be solid acid or salt including ruthenium (Ru), cobalt (Co), nickel (Ni), copper (Cu), iron (Fe) or compound manufactured by the ions thereof.

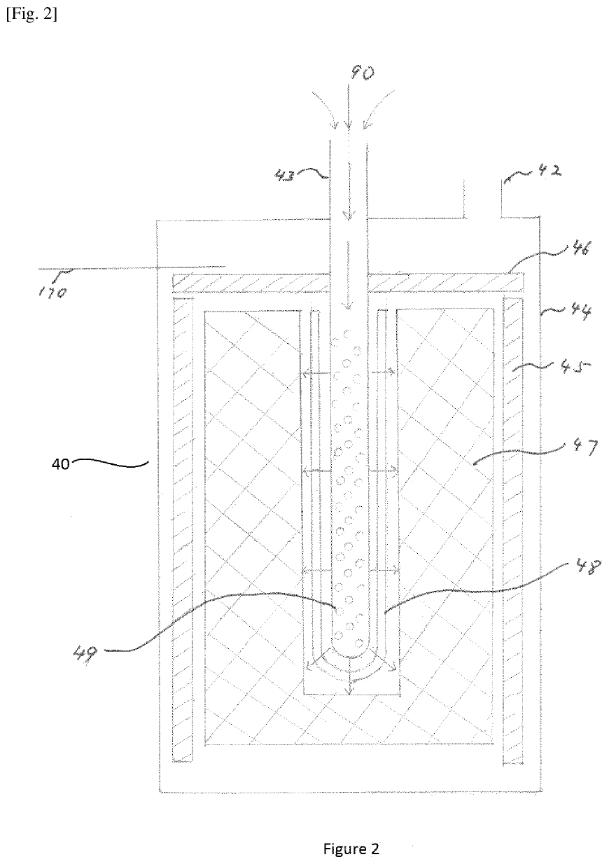

Referring to FIG. 2, there is shown a cross-sectional view of a reaction chamber (40) in an embodiment of the present invention. This reaction chamber (40) is encased in a casing (44), which in a preferred embodiment is made from a metallic material. This reaction chamber (40) is provided on its top side with an intake port (43), said intake port (43) adapted to receive heated reactant (90) from the liquid heating unit (50) for filling said heated reactant (90) into the reaction chamber (40).

In preferred embodiments, the intake port (43) is a pipe structure, or a plurality of pipe structures protruding into the reaction chamber (40). At an end of the pipe structure (43) that protrudes into the reaction chamber (40), there is provided a plurality of holes (49) that allow said heated reactant (90) to be expelled from the pipe structure (43) and into the reaction chamber (40). The plurality of holes (49) is surrounded by a first porous material (48).

In another preferred embodiment, the intake port (43) is a sprayer nozzle, adapted to spray heated reactants in liquid or gaseous state into the reaction chamber (40).

In a preferred embodiment, the pipe structure (43) and the first porous material (48) are disposed in concentric arrangement with respect to the reaction chamber (40), when looked at from a top side of the reaction chamber (40). The pipe structure (43) is located at the center of the concentric arrangement, and is enclosed concentrically by the first porous material (48). The first porous material is in turn enclosed concentrically by the solid reactant (47). The first porous material (48) is permeable to the heated reactant (90) but not to the solid reactant (47). In this way, the first porous material (48) allows the heated reactant (90) to pass into the solid reactant (47) but it does not allow the solid reactant (47) from escaping the reaction chamber (40).

Thus, when the heated reactant (90) is introduced into the reaction chamber (40) through the pipe structure (43), it diffuses out through the plurality of holes (49), through the first porous material (48), and is dispersed into the solid reactant (47), with which it reacts chemically. Hydrogen gas is produced by this chemical reaction. This hydrogen gas permeates through a second porous material (46) located at a top side of the solid reactant (47) and expelled from the reaction chamber (40) through the gas outlet (42). The solid reactant (47) is further encapsulated around its side by a third porous material (45). This third porous material (45) allows the hydrogen gas to permeate through, but it does not allow the solid reactant (47) to pass through. This prevents any melting of the solid reactant (47) from blocking the hydrogen gas passage to the top of the reaction chamber (40). In a preferred embodiment, the first, second and third porous materials are carbon cloth.

Still referring to FIG. 2, there is shown a temperature sensing means (170) adapted to measure a temperature reading within the reaction chamber (40), this temperature reading then sent to the control unit (10). When this temperature reading reaches a preset value, the control unit (10) is able to shut down the reaction in the reaction chamber (40) by closing the control valve (52) thereby stopping the supply of heated reactant (90) into the reaction chamber (40). This is a safety measure.

In one preferred embodiment, the reaction chamber (40) is a fixed part whereby the waste byproduct has to be cleaned out. In another preferred embodiment, the reaction chamber (40) is mounted on the generator system using coupling means to facilitate easy removal and replacement of the entire reaction chamber (40), along with the waste byproduct inside it.

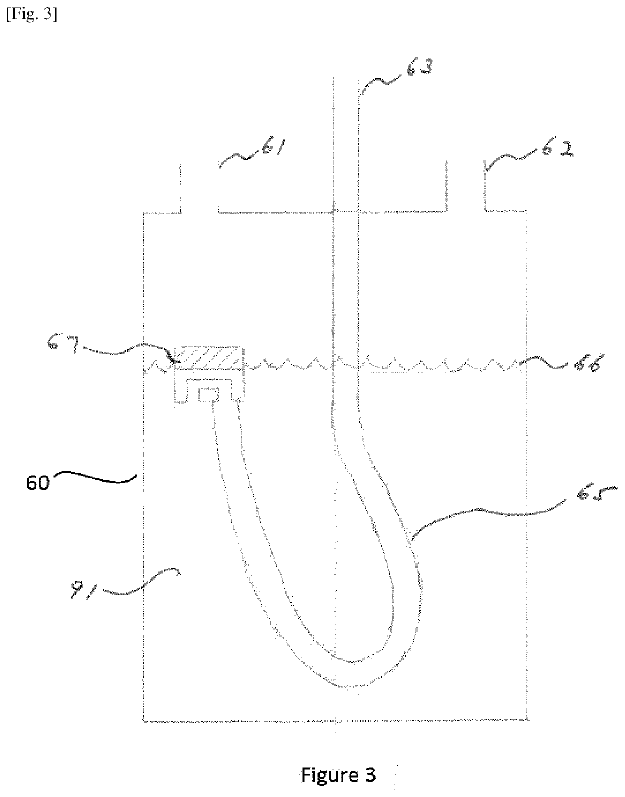

Referring now to FIG. 3, there is shown a cross-sectional view of a liquid storage (60) in an embodiment of the present invention. Liquid reactant (91) is filled into the liquid storage (60) through an intake port (61) from an external source. An exhaust port (63) channels the liquid reactant (91) out from the liquid storage (60).

In FIG. 3, there is shown a flexible hose (65) with a first end connected to a floatation device (67), and a second end in fluid communication with the exhaust port (63). The floatation device (67) is adapted to float on a liquid storage level (66), and to keep the said first end of the flexible hose (65) underneath the surface level of said liquid reactant (91), as long as there is adequate liquid reactant (91) in the liquid storage (60). In this way, the flexible hose (65) is able to extract liquid reactant (91) from the liquid storage (60) regardless of the orientation of the liquid storage (60).

Still referring to FIG. 3, there is provided a return port (62) on the liquid storage (60) for receiving excess liquid from the condensation unit (70).

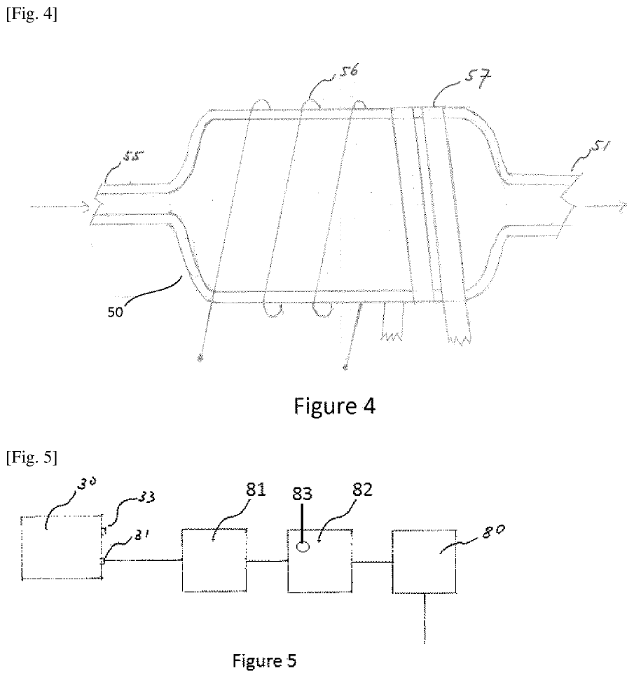

Referring to FIG. 4, there is shown an external and cross-sectional view of a liquid heating unit (50) in an embodiment of the present invention. The liquid heating unit (50) is provided at a first end with an intake port (55) for receiving liquid reactant (91) from the liquid storage (60) via the liquid driving unit (64). The liquid heating unit (50) is provided at a second end with an exhaust port (51) for expelling heated reactant (90) out of the liquid heating unit (50). The intake port (55) has a narrower flow channel than the exhaust port (51). This narrower flow channel allows less of the liquid reactant (91) to enter the liquid heating unit (50), thus allowing an easier conversion of the liquid reactant (91) into the heated reactant (90). The larger diameter of the exhaust port (51) also allows a higher throughput for the heated reactant (90) as it is expelled out from the liquid heating unit (50). The liquid heating unit (50) is provided with heating elements (56) for heating and gasifying the liquid reactant (91).

The liquid heating unit (50) is further provided with a heat conductive means (57) located on the exterior of the liquid heating unit (50). This heat conductive means (57) channels excessive heat from the heat transfer device (53) to the liquid heating unit (50).

Referring now to FIG. 5, there is shown a diagrammatic view of a portion of a hydrogen generating system in an embodiment of the present invention with the addition of a gas regulator (81). This gas regulator (81) is located after the buffer tank (82) and before the fuel cell (30) and in fluid communication with both the buffer tank (82) and an intake port (31) of the fuel cell (30). This gas regulator (81) controls the pressure and flow rate of the hydrogen gas that passes through it. There can be embodiments with just one gas regulator or a cluster of gas regulators. In a preferred embodiment, this gas regulator (81) is controlled by the control unit.

While several particularly preferred embodiments of the present invention have been described and illustrated, it should now be apparent to those skilled in the art that various changes and modifications can be made without departing from the spirit and scope of the invention. Accordingly, the following claims are intended to embrace such changes, modifications, and areas of application that are within the scope of this invention.

### REFERENCE SIGNS LIST

Control unit (10)
Recharge interconnect (12)
Energy storage (13)
Pressure sensing means (14)
Heating controlling output (15)
Electric power converter (20)
Electric load (21)
Load interconnect (22)
Fuel cell (30)
Fuel cell intake port (31)
Fuel cell exhaust (33)
Reaction chamber (40)
Gas flow guide (41)
Reaction chamber gas outlet (42)
Reaction chamber intake port/pipe structure (43)
Reaction chamber casing (44)
Third porous material (45)
Second porous material (46)
Solid reactant (47)
First porous material (48)
Plurality of holes (49)
Liquid heating unit (50)
Liquid heating unit exhaust port (51)
Control valve (52)
Heat transfer device (53)
Heat conductor (54)
Liquid heating unit intake port (55)
Heating element (56)
Heat conductive means (57)
Liquid storage (60)
Liquid storage intake port (61)
Liquid storage return port (62)
Liquid storage exhaust port (63)
Liquid flow guide (635)
Liquid driving unit (64)
Flexible hose (65)
Liquid storage level (66)
Floatation device (67)
Condensation unit (70)
Condensation unit intake port (71)
Condensation unit exhaust port (72)
Condensation unit excess liquid port (73)
Filter unit (80)
Gas regulator (81)
Buffer tank (82)
Buffer tank pressure sensor (83)
Heated reactant (90)
Liquid reactant (91)
Gaseous release controlling output (152)
Liquid driving unit controlling output (164)
Temperature sensing means (170)

1. A hydrogen generating system, comprising:
a control unit;
a liquid storage having an intake port for receiving liquid reactant from an external source, an exhaust port for expelling liquid reactant from said liquid storage;
a liquid heating unit having an exhaust port, an intake port for receiving liquid reactant from said liquid storage, heating elements controllable by said control unit, said liquid heating unit adapted to heat an amount of liquid reactant such that a portion of said liquid reactant enters a gaseous phase;
a reaction chamber having an intake port in fluid communication with said liquid heating unit exhaust port via a control valve, said control valve controlled by said control unit, said reaction chamber containing a solid reactant and adapted to receive an amount of heated reactant from the said liquid heating unit, which said heated reactant is dispersed through said solid reactant thereby producing at least a product gas, said product gas being at least a mixture of said heated reactant and hydrogen gas, and said product gas expelled from the reaction chamber via a gas outlet;
a heat transfer means adapted to transfer heat from said reaction chamber to said liquid heating unit; and
a condensation unit having an intake port for receiving said product gas from said reaction chamber, an exhaust port for channeling primarily hydrogen gas out of said condensation unit, said condensation unit adapted to substantially condense said heated reactant
wherein the system further comprises a buffer tank located downstream of said condensation unit, said buffer tank adapted to receive and store an amount of hydrogen gas, said buffer tank provided with a pressure sensing means and wherein a pressure of said buffer tank is used to ascertain a start and stop of hydrogen gas generation in the said hydrogen generation system.

2. A hydrogen generating system according to claim 1, further comprising a filter unit adapted to filter said primarily hydrogen gas thereby substantially removing unwanted particles from said primarily hydrogen gas.

3. A hydrogen generating system according to claim 1, further comprising a liquid driving unit provided between the said liquid storage exhaust port and said liquid heating unit intake port, and adapted to propel liquid reactant from said liquid storage and into said liquid heating unit, said liquid driving unit controllable by the said control unit.

4. A hydrogen generating system according to claim 1, further comprising a control valve adapted to allow release of said heated reactant from said liquid heating unit, said control valve controllable by the said control unit.

5. A hydrogen generating system according to claim 1, wherein said liquid heating unit is adapted to store an amount of said heated reactant.

6. (canceled)

7. A hydrogen generating system according to claim 1, further comprising a fuel cell adapted to generate electricity from a supply of hydrogen gas, said fuel cell located downstream of said buffer tank, and an energy storage, said energy storage adapted to receive and store an amount of electrical energy from said fuel cell, a storage level of said energy storage relayed to said control unit.

8. A hydrogen generating system according to claim 7, wherein hydrogen gas stored in said buffer tank is released and sent to said fuel cell when said storage level of said energy storage is reduced to a preset level.

9. A hydrogen generating system according to claim 1, further comprising a means of ensuring that the liquid reactant flows out of the liquid storage so long as there is adequate liquid reactant in said liquid storage.

10. A hydrogen generating system according to claim 9, wherein said means of ensuring that the liquid reactant flows out of the liquid storage comprises a flexible hose with a first end connected to a floatation device, and a second end in fluid communication with said liquid storage exhaust port, and such that said floatation device is adapted to keep said first end of flexible hose underneath a surface of said liquid reactant as long as there is adequate liquid reactant in the liquid storage.

11. A hydrogen generating system according to claim 1, wherein the said liquid reactant includes any of: water, acidic liquid, alkaline liquid, organic or inorganic liquids or a combination thereof.

12. A hydrogen generating system according to claim 1, wherein the said solid reactant comprises of a mixture of hydrogen fuel and a metal based catalyst.

13. A hydrogen generating system according to claim 12, wherein the said hydrogen fuel is sodium borohydride.

14. A hydrogen generating system according to claim 12, wherein the said hydrogen fuel is any of: boron hydride, nitrogen hydride, carbon hydride, metal hydride, boron nitrogen hydride, boron carbon hydride, nitrogen carbon hydride, metal boron hydride, metal nitrogen hydride, metal carbon hydride, metal boron nitrogen hydride, metal boron carbon hydride, metal carbon nitrogen hydride, boron nitrogen carbon hydride, metal boron nitrogen carbon hydride, or the combination thereof.

15. A hydrogen generating system according to claim 12, wherein the said hydrogen fuel is any of: NaH, LiBH4, LiH, CaH2, Ca(BH4)2, MgBH4, KBH4, Al(BH3)3, or the combination thereof.

16. A hydrogen generating system according to claim 12, wherein the said solid reactant may be various compounds having BxNyHz, where x, y and z are any integer numbers.

17. A hydrogen generating system according to claim 16, wherein the said various compounds include: H3BNH3, H2B(NH3)2BH3, NH2BH2, B3N3H6, morpholineborane, (C4H12BNO), (CH2)4O composite material, B2H4, or a combination thereof.

18. A hydrogen generating system according to claim 12, wherein the said metal based catalyst is any of: a cobalt based oxide, a boride, a solid acid, a salt, or a combination thereof.

19. A hydrogen generating system according to claim 18, wherein the said salt is a compound of the ions of any of: ruthenium (Ru), cobalt (Co), nickel (Ni), copper (Cu), iron (Fe) or a combination thereof.

20. A hydrogen generating system according to claim 1, further comprising a gas regulating means located after a filter and before said buffer tank, said gas regulating means adapted to regulate a pressure and flow rate of a gas passing through it.

21. A hydrogen generating system according to claim 1, wherein the reaction chamber is easily removable from the system and provided with means of temporarily closing the intake port and gas outlet during its removal.

22. A hydrogen generating system according to claim 1, wherein the said heating elements can be operated electrically by resistive heating or inductive heating.

23. A hydrogen generating system according to claim 1, wherein the said condensation unit further comprises an excess liquid port for channeling a condensate of said heated reactant out of said condensation unit and back into said liquid storage.

24. A hydrogen generating system according to claim 1, further comprising a pressure sensing means for taking a pressure reading of said reaction chamber and relaying said pressure reading to said control unit, said control unit stopping the hydrogen gas generation in the reaction chamber if said reaction chamber pressure reading exceeds a preset value.

25. A hydrogen generating system according to claim 1, further comprising a temperature sensing means for taking a temperature reading of said reaction chamber and relaying said temperature reading to said control unit, said control unit stopping the hydrogen gas generation in the reaction chamber if said reaction chamber temperature reading exceeds a preset value.

26. A method of generating hydrogen gas, comprising the following steps:
detect a pressure level of a buffer tank;
if said pressure level has reduced to a predetermined level, activate a liquid driving unit that propels a liquid reactant from a liquid storage into a liquid heating unit;
activate heating elements in said liquid heating unit such that at least a portion of the said liquid reactant is heated;
allow the said heated reactant to disperse inside a reaction chamber containing an amount of solid reactant, the contact between the said heated reactant and solid reactant producing hydrogen gas;
condense any heated reactant mixed with said hydrogen gas to separate it from the said hydrogen gas;
transferring an amount of heat generated in the said reaction chamber to the said liquid heating unit;
return said condensed heated reactant to said liquid storage;
filter said hydrogen gas to substantially remove unwanted materials; and
store said hydrogen gas in said buffer tank.

28. (canceled)

29. A method of generating hydrogen gas according to claim 5, further comprising the following step:
regulating a pressure and flow rate of the said hydrogen gas.
